(19) United States
(12) Patent Application Publication
(10) Pub. No.: US 2012/0109745 A1
(43) Pub. Date: May 3, 2012

(54) NEWS COMMENT RELATED ONLINE ADVERTISING

(75) Inventor: Narayan L. Bhamidipati, Bangalore (IN)

(73) Assignee: Yahoo! Inc., Sunnyvale, CA (US)

(21) Appl. No.: 12/916,244

(22) Filed: Oct. 29, 2010

(51) Int. Cl. G06Q 30/00; G06F 15/18

(52) U.S. Cl. 705/14.49; 706/12

(57) ABSTRACT

Techniques are provided relating to online advertising in connection with news comments. Information may be obtained indicating that an online user is engaged in news comment viewing or interaction activity, including interacting one or more comments, such as user comments, following or displayed below a news article on a Web page. An online advertisement may be targeted to the online user based at least in part on the activity, such as by being targeted based on a topic or opinion associated with the one or more news comments, or of a reply or other action of the online user.

### BACKGROUND

Increasingly, on a Web page including a news article, comments, such as user comments, follow or are displayed below. Users who read or interact with such news comments represent an extremely valuable segment for online advertisers. For example, they are generally highly interested, motivated, focused, attentive, and often interactive. Yet advertising techniques associated with such users have not been optimized.

### SUMMARY

Some embodiments of the invention provide techniques relating to online advertising in connection with news comments. Information may be obtained that indicates that an online user is engaged in news comment viewing or interaction activity, including interacting with one or more comment such as user comments, following or displayed below a news article on a Web page. An online advertisement may be targeted to the online user based at least in part on the activity, such as by being targeted based on a topic or opinion associated with the one or more news comments, or of a reply or other action of the online user. The online advertisement may be served to the online user, such as while the online user is engaged in the activity.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

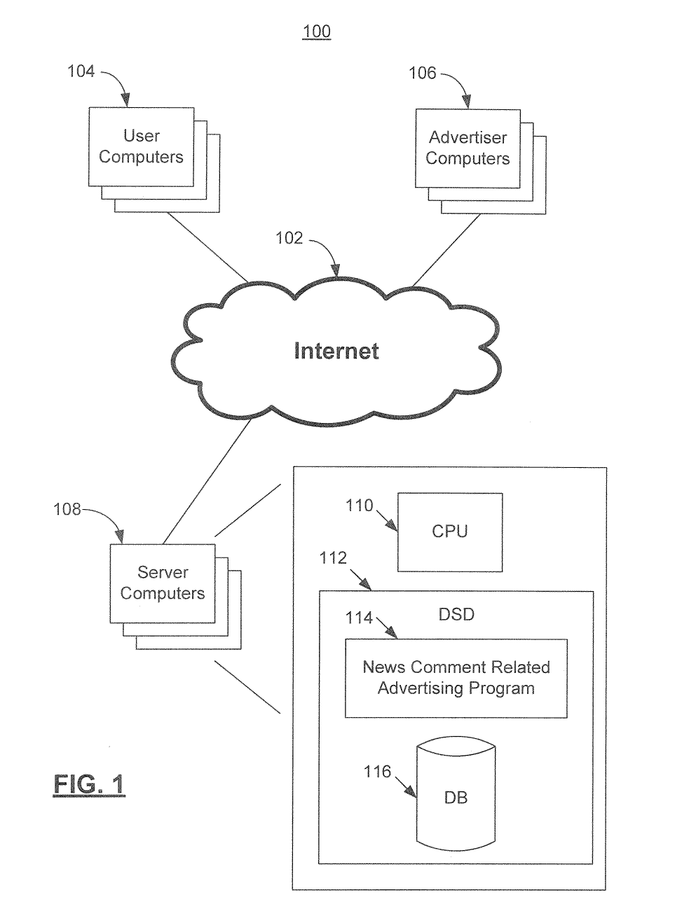

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, ding textual advertisements, rich advertisements, video advertisements, etc.

As depicted, each of the server computers 108 includes one or more CPUs 110 and a data storage device 112. The data storage device 112 includes a database 116 and a News Comment Related Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

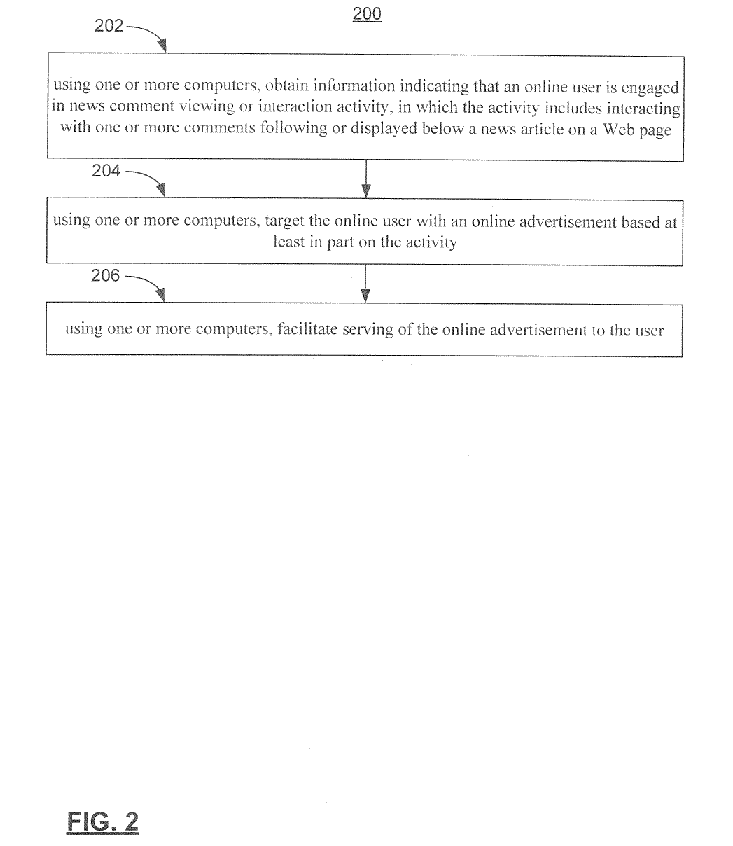

FIG. 2 is a flow diagram illustrating a method 200 according to one embodiment of the invention. At step 202, using one or more computers, information is obtained indicating that an online user is engaged in news comment viewing or interaction activity. The activity includes interacting with one or more comments following or displayed below a news article on a Web page.

At step 204, using one or more computers, the online user is targeted with an online advertisement based at least in part on the activity.

At step 206, using one or more computers, the method 200 includes facilitating serving of the online advertisement to the user.

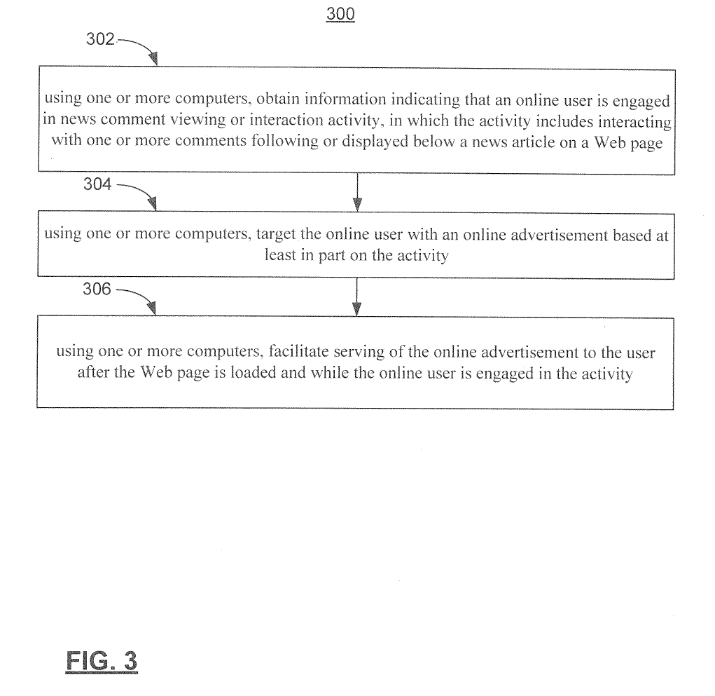

FIG. 3 is a flow diagram illustrating a method 300 according to one embodiment of the invention. Steps 302 and 304 are similar to steps 202 and 204 of the method 200 depicted in FIG. 2.

At step 306, using one or more computers, the method 300 includes facilitating serving of the online advertisement to the user after the Web page is loaded and while the online user is engaged in the activity.

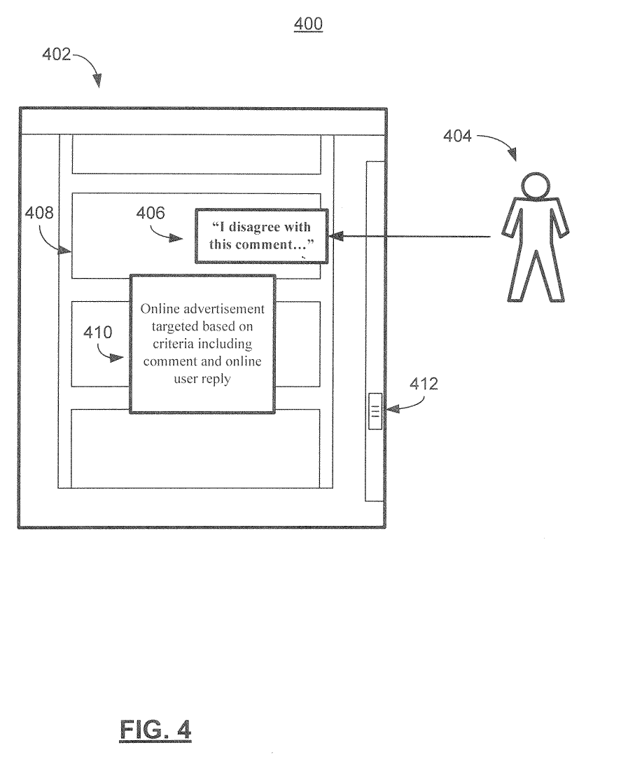

FIG. 4 is a block diagram 400 illustrating one embodiment of the invention. A graphical user interface, or screen display 402, is depicted, being viewed by an online user 404. A series of user comments, including user comment 408, are depicted. The comments follow a news article, but the news article itself is not displayed since the online user 404 has scrolled past it, using the scroll bar 412, and on to the user comment section.

As depicted, the user 404 is interacting with the user comment 408. Specifically, the user 404 is or has posted a reply comment 406, which includes a statement indicating that the user disagrees with the user comment 408.

An online advertisement 410 is targeted to and served to the online user 404, based on criteria including the user comment 408 and the reply comment 406, or partial reply comment, of the user 404.

For example, the news article might be about a certain brand of food. The user comment 408 might express an opinion about the brand of food, such as a favorable opinion, and may include specific details. The reply comment 406 might indicate that the user 404 disagrees with the user comment 408 and has a favorable opinion of the brand of food, and may include specific details, such as a certain particular products of that brand that the user 404 thinks are particularly appealing. The online advertisement 410 may be displayed to the user while the user is viewing the comments section, or while the user is writing or has just posted the reply comment 406. The online advertisement may, for example, advertise one of the particular food products of that brand which the user 404 has indicated that he or she feels are particularly appealing. As such, the online advertisement is highly targeted and relevant, presented to an engaged, active, enthusiastic user.

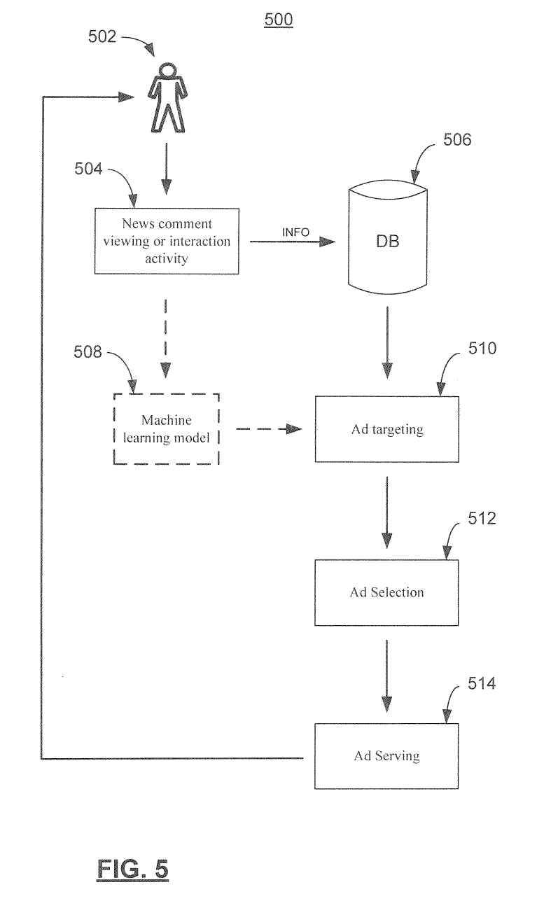

FIG. 5 is a block diagram 400 illustrating one embodiment of the invention. An online user 502 is depicted, who is engaged in news comment viewing or interaction activity 504. Information regarding the activity is stored in one or more databases 506.

Advertisement targeting 510 is performed based at least in part on the activity. One or more machine learning models may be used in the advertisement targeting 510.

Advertisement selection 512 is performed based at least in part on the advertisement targeting 510.

Advertisement serving 514 is performed, including serving of a selected advertisement to the online user 50n2.

Some embodiments of the invention include a recognition that online users spend a lot of time on activities such as reading, rating and writing comments, such as while traversing multiple comment pages. This behavior can indicate that the user is active as well as very interested in very specific topics. Comments sections can also be the portion that captures the attention of the most passionate users who are exactly what the advertisers may be looking for. Some embodiments of the invention include understanding user interests in real time, such as while the user is in the comments section, and include using this for better interaction with the user, such by showing more relevant advertisements, improving the user experience with information or tools, etc.

Some embodiments include a recognition that Web sites such as Web portals may aim to not only increase their audience, but also the engagement levels of their users. Engagement can take the form of any of various activities that the user may perform on the website. Such activities could include viewing content or advertisements, which may be more passive, or clicking on links or advertisements, which may be more active or explicit. Passive activities do provide some information about the user's interests. However, the explicit ones may be more reliable, as users express their intent through very specific actions.

For a news article, standard machine learning techniques can identify a small number of broad categories that the article could be classified into. Confidence scores may be attached to the classifications to rank order the various categories. Nevertheless, the wide variety of terms present in the article, while necessary for reinforcing the confidence in a broad topic, can prevent pinpointing the specific subcategory that a particular user has reached this page for. Observing that a user has read a news article does not tell much about the user, except for a general interest in a broad category.

However, once the user reaches the comments section, the user's activity may become more specific, interactive, and more measurable. There may be buttons for “like” and “dislike” (or “buzz up” and “buzz down”), which the user may click to explicitly express an interest, or lack thereof, in very specific topics encapsulated in a comment. This can help in knowing precisely what the user likes, and what she does not. There may also be the “report abuse” link which might indicate intense opposition to certain topics. There may also be the “reply” subsection, where a user may look at other replies to a comment, or add her own. These activities can provide a plethora of positive and negative examples that may be used, such as including use of machine learning techniques, to accurately infer the exact interests of the user. For example, one may identify that this is an article that may be identified as “Sports/Golf”, hut the user may be more interested in “Sports/Golf/Tiger Woods”. While this need not be evident from the article itself, as it might mention many other players, by interacting with comments specific to “Tiger Woods”, the user would reveal more about herself. In addition, interest may be classified as either positive or negative. For example, buzzing down a comment like “Tiger is the greatest” is a clear indication of the negative sentiment about Tiger Woods that this user holds. Some of the above-mentioned activities might have a very short life span, and their associated interest categories might be short lived, too. For example, any interest inferred from a comment about the score of an ongoing match might remain active only for the duration of the match. The right time to target based on this, such as may include the use of machine learning techniques, would perhaps be during or a few minutes to a few hours since comment was made. Accurately identifying the interests of a use can have several ramifications. These include, for example: monetization of the comments section; improving experience by showing more relevant advertisements, or even none at all, if no other ad is appropriate; improving the image of the Web site by providing helpful information or navigational links identifying the most passionate and engaged users; redirecting a user to other parts of the Web site; and, helping users construct replies.

In some embodiments, the additional knowledge of current interests of the user may help allow selection of more relevant advertisements. For instance, in the aforementioned example about Tiger Woods, once the system zeroes in to “Tiger Woods” as the specific category of interest, rather than the more generic “Sports/Golf” category, advertisements featuring Tiger Woods may be served. Advertisers may even select user interest categories such as “Tiger Woods Fans”, and advertisements that do not directly feature Tiger Woods, but are somehow related (based on the fact that the advertisers have specifically selected this category) may also be served. Moreover, one may also take the sentiment of the user into account. The actions, in tandem, for example, with some simple Natural Language Processing (NLP) techniques, may help identify the kind of opinion held for this specific subtopic. So, while the user might be immensely interested in Golf, he might not like Tiger Woods much, and an advertisement featuring him would be a bad choice. Instead, an advertisement featuring another golfer, if it is made explicit, or a generic golf related advertisement may be shown. If the user is sensed to have a negative sentiment about the Democrats, one may be better off showing an advertisement by the Republicans, even though the user has not specifically shown any explicit behavior in favor of the Republicans. Finally, one may also conclude that the user is not keenly interested in any of the specific interest categories of advertisements in the available inventory. In such cases, a conscious decision of not showing those advertisements might be the most relevant action and may enhance user experience. This would also help prevent the click through rate of various advertisements from plunging down.

Sometimes, comments are similar to certain frequently asked questions (FAQs). They might be either related to the Web site itself (for example, questions like “where is the slideshow mentioned in this article?”, or “how do you delete a comment?”), in which case a helpful link to the FAQ page or the help section of the neb site would be very useful. Helping the user in a timely manner enhances the reputation of the Web site as being user-friendly. In addition, it might save the Web site some customer care cycles which might otherwise require manually looking into the user's complaints. Some other comments might be questions that have been answered elsewhere. For example, a comment about a newly released gadget might be about how to operate it effectively. This might be a question that has already been answered on Yahoo! Answers, and pointing the user to such a section would satisfy the needs of the user much quicker. As another example, while the user is posting a comment about how much the gadget costs, she may be provided with a link to a page containing the answer. If the user was asking for the price, this would answer her question. On the other hand, if she was trying to answer somebody's question and wanted to quote the price, this link would serve as a reference in support of her answer. Interactions of the kind mentioned here are of a symbiotic nature, whereby both the users and the website stand to gain. The goodwill gained by the website can further enhance the stickiness or loyalty of the user and may attract other users.

Some embodiments include a recognition that monitoring activity can help identify the most valuable users. These may be not only active users, but also those who interact with other users on the network. This social aspect also provides a way of employing methods like collaborative filtering, whereby inferences drawn on neighbors and similar users may be generalized to the present user.

In some embodiments, users may be redirected to other portal properties based on their actions. Also, when appropriate, links to search may be provided. In addition, the system can help connect active users with similar interests. For example, one may be able to point the current user to other comments that might be of interest, either on the present article or elsewhere. Users may also be pointed to comments that they are not likely to agree with. These are typically the comments that the user would like to counter with a comment of her own.

Some embodiments include a recognition that, at times, users are groping for information while constructing replies to comments. Keeping a watch for certain keywords, or using some basic NLP techniques, one may be able to understand the information needs of a user, and provide either answers or hints, immediately. If a user types in “I don't know how much a Prius costs, but . . . ”, the system can show the price of a Prius, with a link for more information. Again, if user A has claimed that Honda cars are not fuel efficient, an advertisement for a fuel efficient Honda car would help user B confidently reply to that comment. Also, before a user posts a comment, the system may make some predictions about how many users may see it, how it might be rated (this could based both on textual analysis, as well as the activity of other users), or who is likely to reply, and possibly even what the reply could be. For example, some users post a comment like “it is all Obama's fault”, no matter what the news article is. Suggesting that “7 users are likely to call this irrelevant” might discourage the user from posting that comment, and help keep the comments section clean.

While the invention is described with reference to the above drawings, the drawings are intended to be illustrative, and the invention contemplates other embodiments within the spirit of the invention.

1. A method comprising:
using one or more computers, obtaining information indicating that an online user is engaged in news comment viewing or interaction activity, wherein the activity includes interacting with one or more comments following or displayed below a news article on a Web page;
using one or more computers targeting the online user with an online advertisement based at least in part on the activity; and
using one or more computers, facilitating serving of the online advertisement to the user.

2. The method of claim 1, comprising serving the online advertisement to the online user.

3. The method of claim 1, comprising serving the online advertisement to the online user while the online user is engaged in the activity.

4. The method of claim 1, comprising obtaining information indicating that an online user is engaged in news comment viewing or interaction activity, wherein the information comprises scrolling information.

5. The method of claim 1, comprising obtaining information indicating that an online user is engaged in news comment viewing or interaction activity, wherein the activity includes reading one or more user comments.

6. The method of claim 1, wherein the activity comprises interaction with a news comment.

7. The method of claim 1, wherein the activity comprises interaction indicating a favorable or unfavorable response to a news comment.

8. The method of claim 1, wherein the activity comprises a reply or comment n response to a news comment.

9. The method of claim 1, wherein the targeting comprises utilizing a machine learning model.

10. The method of claim 1, comprising facilitating serving of the online advertisement to the online user, wherein the online advertisement is an informational advertisement providing information relating to the activity.

11. The method of claim 1, comprising facilitating serving of the online advertisement to the online user, wherein the online advertisement provides assistance to the online user associated with the activity.

12. The method of claim 1, wherein the targeting relates at least in part to a topic or opinion associated with the activity or with a news comment associated with the activity.

13. The method of claim 1, wherein the online advertisement is displayed after the Web page loaded and while the online user is engaged in the activity.

14. The method of claim 1, wherein the online advertisement is displayed after the Web page is loaded and while the user is scrolled down the Web page so as to be viewing news comments.

15. A system comprising:
one or more server computers coupled to a network; and
one or more databases coupled to the one or more server computers;
wherein the one or more server computers are for:
using one or more computers, obtaining information indicating that an online user is engaged in news comment viewing or interaction activity, wherein the activity includes interacting with one or more comments following or displayed below a news article on a Web page;
using one or more computers, targeting the online user with an online advertisement based at least in part on the activity; and
using one or more computers, facilitating serving of the online advertisement to the user.

16. The system of claim 15, comprising serving the online advertisement to the online user.

17. The system of claim 15, comprising serving the online advertisement to the online user while the online user is engaged in the activity.

18. The system of claim 15, comprising serving the online advertisement to the online user after the Web page is loaded and while the online user is engaged in the activity.

19. The system of claim 15, comprising serving the online advertisement to the online user after the Web page is loaded and while the online user is scrolled down the Web page so as to be viewing news comments.

20. A computer readable medium or media containing instructions for executing a method comprising:
using one or more computers, obtaining information indicating that an online user is engaged in news comment viewing or interaction activity, wherein the activity includes interacting with one or more comments following or displayed below a news article on a Web page;
using one or more computers, targeting the online user with an online advertisement based at least in part on the activity; and
using one or more computers, facilitating serving of the online advertisement to the user after the Web page is loaded and while the online user is engaged in the activity.
